(19) United States
(12) Patent Application Publication
(10) Pub. No.: US 2018/0345704 A1
(43) Pub. Date: Dec. 6, 2018

(54) Method of re-inking a tape

(71) Applicant: Dover Europe Sarl, Vernier (CH)

(72) Inventors: Mohammed Jamal Toudmeri, Birmingham (GB); Simon Starkey, Ashby-de-la-Zouch (GB)

(21) Appl. No.: 15/994,761

(22) Filed: May 31, 2018

(30) Foreign Application Priority Data
Jun. 1, 2017 (GB) GB1708757.8

(51) Int. Cl. B41J 31/14

(52) U.S. Cl. CPC B41J 31/14

(57) ABSTRACT

A re-inking device and a method of re-inking a tape include use of an application mechanism, where at least a part of the tape is wound onto each of first and second spools, and the tape extends between the first and spools along a tape path, the first and second spools being mounted to a cassette of a thermal printing apparatus. The method can include mounting the cassette on the re-inking device, initialising the re-inking device by moving at least one of the tape and the application portion to bring the tape into an ink-application position, and coating at least a portion of the tape with ink by supplying ink to the application portion and rotating at least one of the first and second spools to move the tape relative to the application portion, so that ink coats at least a portion of the tape.

### BACKGROUND

Embodiments of the present invention relate to a method of re-inking a tape and an apparatus for the same—particularly, but not exclusively, to re-inking a tape for a thermal printing apparatus.

Thermal transfer printing apparatuses are well known in the art. Typically, a thermal printing apparatus includes a pair of spools onto which tape (also known as ribbon) is wound. The tape extends between the spools (and usually passes around one or more guide members). A printhead is positioned on a “non-inked” side of the tape and moves to sandwich the tape between the printhead and a substrate. Heating elements on the printhead are selectively heated to melt portions of the ink on the tape and transfer ink onto the substrate, in order to print an image and/or text.

Once the ink has been removed from a portion of the tape, a motor rotates one or both of the spools to move the tape relative the printhead, so that one or more unused portions of ink are presented to the printhead and can be melted onto the substrate. This process is typically repeated many times and, as such, the tape has less and less ink available to be used in successive printing operations. Typically, the tape is “single use”, and once it has been used in the printing apparatus it is discarded.

One of the disadvantages with this process is that each “printing operation” by the printhead to remove ink from the tape often does not remove all of the ink from a portion of tape—thus, there is often a lot of ink left unused on the tape when it is discarded. The percentage of ink left on the tape is often around 80%. This leads to wastage of materials and is not very environmentally friendly.

U.S. Pat. No. 8,922,611 discloses a thermal transfer apparatus which includes a band capable of holding hot melt ink and which is supported by rollers. GB2543061 discloses a printing apparatus which includes a slot die to apply ink to a band that holds hot melt ink. Neither of these systems is available to users of existing thermal transfer printing systems as they can only be used with a continuous band for holding ink.

### SUMMARY

Embodiments of the present invention seek to alleviate one or more problems associated with the prior art.

In accordance with a first aspect of the present invention, there is provided a method of re-inking a tape, at least a part of the tape being wound onto each of a first spool and second spool and the tape extending between the first spool and the second spool along a tape path, the first and second spools being mounted to a cassette of a thermal printing apparatus, the method using a re-inking device including an application mechanism, which includes an application portion and a supply of ink configured to supply ink to the application portion, the method comprising:
mounting the cassette on the re-inking device,
initialising the re-inking device by moving at least one of the tape and the application portion relative to the other to bring the tape into an ink-application position, and
coating at least a portion of the tape with ink by supplying ink to the application portion and rotating at least one of the first and second spools to move the tape relative to the application portion, so that ink coats at least a portion of the tape.
The method may include removing the cassette from a thermal printing apparatus, prior to mounting the cassette on the re-inking device.
The method may include providing a moveable guide member which, during the initialising, moves from a first position, to a second position in which the guide member contacts the tape.
At least a part of the application mechanism may be moveable from a first position, to a second position in which the part of the application mechanism is in contact with the tape.
The part of the application mechanism may be the application portion.
The method may include transferring substantially all of the tape onto one of the first spool, or the second spool, prior to initialising the re-inking device.
The method may include moving at least a portion of the tape past the application portion such that at least a portion of the tape is coated with ink, during the coating.
The method may include moving substantially all of the tape past the application portion such that substantially all of the tape is coated with ink, during the coating.
The method may include transferring substantially all of the tape onto the first spool, or second spool, after the coating, so that the cassette is prepared for reinsertion into a thermal printing apparatus.
The method may include monitoring at least one property of the tape in the tape path.
The monitoring may include using a tape tension detector to monitor the tension in the tape and/or an angle detector to monitor the angle of the tape in the tape path.
The method may include correcting or maintaining the tension in the tape in the tape path within acceptable limits or towards a predetermined range.
The method may include correcting or maintaining the angle of the tape in the tape path within acceptable limits or towards a predetermined range when the angle detector detects a divergence from the predetermined range.
Correcting or maintaining the tension and/or the angle of the tape in the tape path may include using a guide member.
The method may include monitoring at least a portion of the ink on the tape to detect the presence and/or absence of ink on the tape, using an ink detector.
Monitoring at least a portion of the ink on the tape may include using an electromagnetic sensor.
Using the electromagnetic sensor may include emitting electromagnetic radiation towards the tape and monitoring the intensity of the electromagnetic radiation that travels through the tape and/or monitoring the intensity of the electromagnetic radiation that is reflected by the tape.
The method may include monitoring the tape for damage and/or wear, using a damage detector.
The method may include alerting an operator and/or a central system of a detected anomaly.
The method may include adjusting a thickness of a portion of the ink coated on the tape using a shaving device.
The coating may include melting at least a portion of existing ink on the tape.
The coating, which results in at least a portion of the tape being coated in ink, may include moving the tape relative to the application portion at a speed of between 0.1 and 0.6 metres per second.
The speed may be around 0.5 metres per second.
In accordance with a second aspect of the invention, there is provided a re-inking device comprising:
   an application mechanism comprising an application portion and a supply of ink, which is operable to supply ink to the application portion;
   the re-inking device being configured to receive and/or engage a cassette of a printing apparatus, the cassette including a first spool and a second spool and a tape of which at least a part is wound onto each of the first spool and the second spool and the tape extending between the first spool and the second spool along a tape path, and
   the re-inking device being operable to apply ink to a portion of the tape when the cassette is received and/or engaged with the re-inking device.

### BRIEF DESCRIPTION OF THE DRAWINGS

Some embodiments of aspects of the invention are described below with reference to the accompanying figures, of which:

FIG. 1 illustrates a printing apparatus;

FIG. 2 illustrates a cassette in accordance with some embodiments of the invention;

FIG. 3 illustrates a cassette and a re-inking device in accordance with some embodiments of the invention; and

FIG. 4 illustrates the cassette and the re-inking device after an initialising step in accordance with some embodiments of the invention.

### DETAILED DESCRIPTION

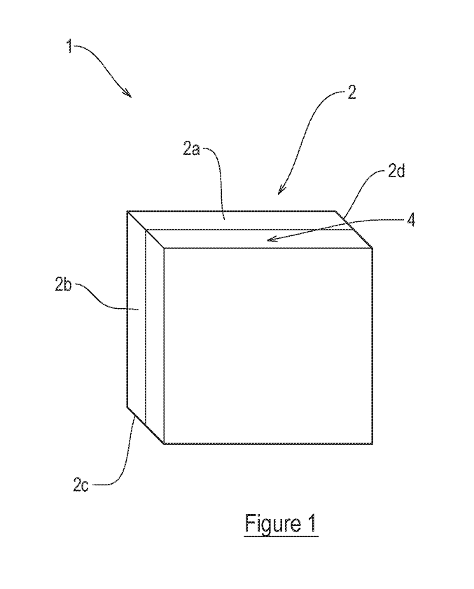

FIG. 1 shows a printing apparatus 1 which includes a main housing 2 and a cassette 4, which is mounted on and/or received in the main housing 2. The printing apparatus 1 is a thermal transfer printer which prints an image and/or text by transferring melted ink from a tape onto a substrate.

The main housing 2 includes a motor or a pair of motors (not shown) and a printhead (not shown). The or each motor is driven by a motor control system (not shown), and the printhead is operated by a control system. The motor control system and the control system may be the same (i.e. a single control unit may control both the motor(s) and the printhead), or the control system and motor control system may be separate (i.e. the motor(s) and printhead are controlled independently by separate control systems).

In the present example, the main housing 2 is a cuboid shape with walls 2a, 2b, 2c, 2d defining an inner volume in which the motor(s) and the printhead are housed. However, it should be appreciated that the main housing 2 can have any number of sides and form any appropriate shape, as desired, and the housing need not be closed on the sides.

The main housing 2 and the cassette 4 are manufactured from metal, for example, stainless steel or aluminium. However, it should be appreciated that the main housing 2 and/or the cassette 4 may be manufactured from any material which provides the necessary strength and rigidity to maintain the shape of the printing apparatus 1 during operation (and over a long lifetime).

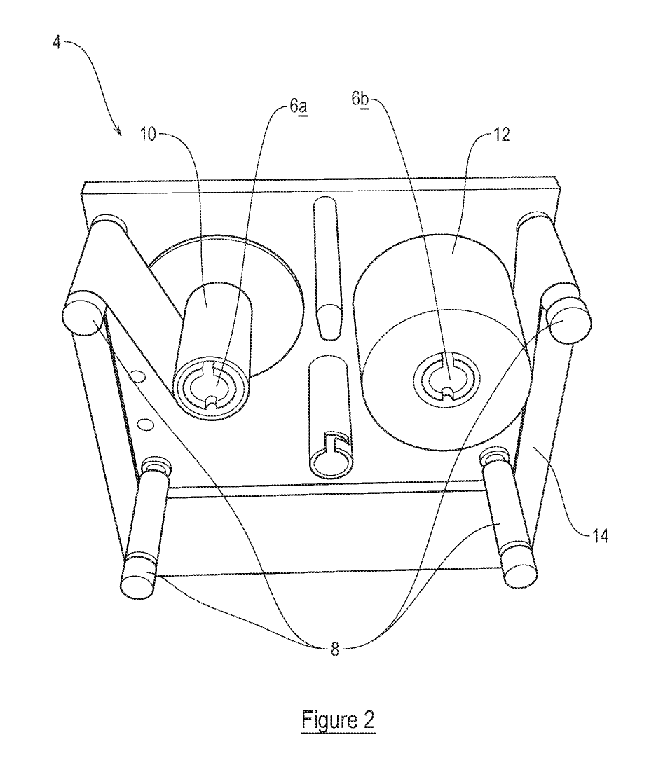

FIG. 2 illustrates the cassette 4 which is mounted to the main housing 2 when the printing apparatus 1 is in use. The cassette 4 includes a pair of spool supports 6a, 6b, which are spaced from one another, and four cassette guide members 8, each of which is positioned in a respective corner position of the cassette 4. It should be appreciated that the cassette 4 may have more than four cassette guide members 8 or fewer, as desired and/or as required.

The first and second spool supports 6a, 6b and the cassette guide members 8 are rotatably attached to the cassette 4 (the guide members 8 are not drivable in this embodiment, but it should be appreciated that they can be drivable by the motor(s) or another motor). A tape 14 (which bears a quantity of ink) is wound onto a first spool 10 and/or a second spool 12, each of which is supported on one of the first and second spool supports 6a, 6b, respectively. The tape 14 extends between the spools 10, 12 and around the cassette guide members 8. The tape 14 is manufactured of a tough engineering plastic or composite that allows re-use. Examples of materials which may be used are polyimide films, metal ribbons, metal ribbons coated with a polyimide film, and polyimide films doped with particles such as iron oxide, aluminium, boron nitrite or graphene nanotubes.

Once the tape 14 is threaded around the cassette guide members 8, the cassette 4 is mounted to and/or received by the main housing 2. When the cassette 4 is mounted on and/or received by the main housing 2, the spool supports 6a, 6b cooperate with the motor(s) of the main housing 2, so that the spool supports 6a, 6b are rotationally drivable by the or each motor. Thus, the motor control system controls rotation of the first and/or second spools 10, 12, so that tape 14 may be transferred between the spools 10, 12, around the cassette guide members 8 (and past the printhead), as desired. In other words, the cassette 4 with the tape 14 fitted may be engaged and disengaged from the main housing 2, as desired.

During a printing operation, the tape 14 is transferred from the one of the spools 10, 12 which acts as a supply spool (which may be the spool 10, 12 upon which a majority of the tape 14 is wound), around the cassette guide members 8 and onto the other spool 12, 10, which acts as a take up spool. It will be appreciated that the tape 14 may be driven in either direction and so either spool 10, 12 may act as the supply spool at a given time, depending upon the direction of travel of the tape 14. The printhead is generally positioned between cassette guide members 8 when the cassette 4 is mounted to and/or received by the main housing 2 (in this case, between the two cassette guide members 8 located adjacent opposing ends of the wall 2c of the main housing 2 (when the cassette 4 mounted on and/or received by the main housing 2)). The printhead moves towards the tape 14, such that the tape 14 is sandwiched between the printhead and a substrate, which is supported on a roller or platen (not shown) adjacent the main housing 2.

The printhead is of a type well known in the art and includes selectively energisable heating elements. During a printing operation, some of the heating elements are heated to melt a portion of the ink on the tape 14. The melted ink transfers onto the substrate.

When all of the tape 14 has been wound from the supply spool 10, 12 onto the take up spool 12, 10, then printing is halted as substantially the entire length of the tape 14 bearing ink has been presented to the printhead at least once (this does not necessarily mean that all of the ink has been available for use since the ink that is removed from the tape 14 must be able to form a complete image and/or text of sufficient quality). As mentioned above, not all of the ink will have been removed from the tape 14, but substantially all of the tape 14 has been fed past the printhead and had some portion of the ink removed (and as such it is unlikely that satisfactory printing can continue from any remaining ink on the tape 14)—thus, operation of the printing apparatus 1 is halted. It should be appreciated that in some instances, the printing apparatus 1 is halted before all of the tape 14 has been fed past the printhead (for example, for maintenance reasons or to change the substrate, etc.), so not all of the tape 14 is necessarily wound on to the take up spool 10, 12 before using a re-inking device 100 discussed below. It is possible for a portion or portions of the tape to be fed past the printhead more than once, by rewinding the tape and then advancing it again, removing different portions of ink to print an image, each time. However, even this method does not adequately increase the proportion of ink which is used, and around 80% of the ink on the tape is still typically wasted.

Some embodiments of a re-inking device 100 and a method of re-inking the tape 14 are described below.

Once the printing apparatus 1 has stopped operation, the cassette 4 is removed from the main housing 2 and transferred to the re-inking device 100. The re-inking device 100 is configured to receive and/or engage the cassette 4. The re-inking device 100 is operable to apply ink to a portion of the tape 14 when the cassette 4 is received by and/or engaged with the re-inking device 100.

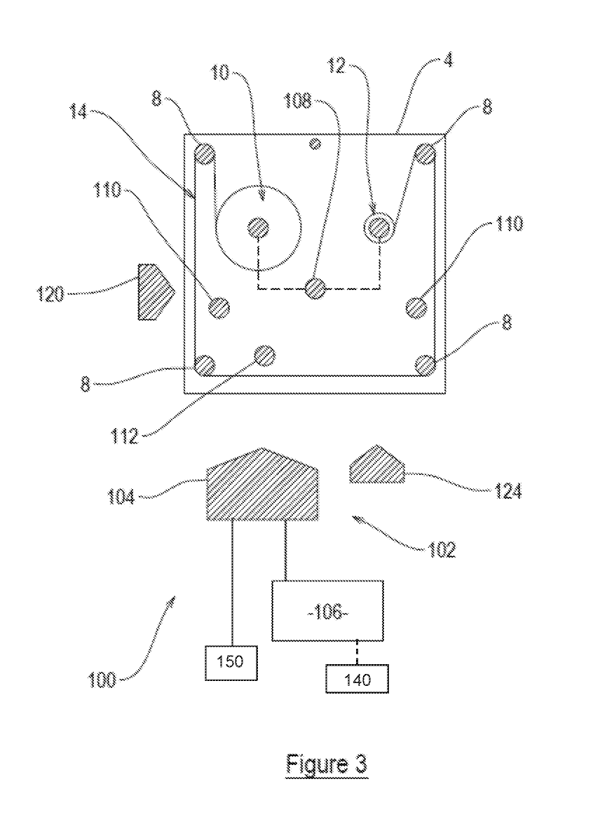

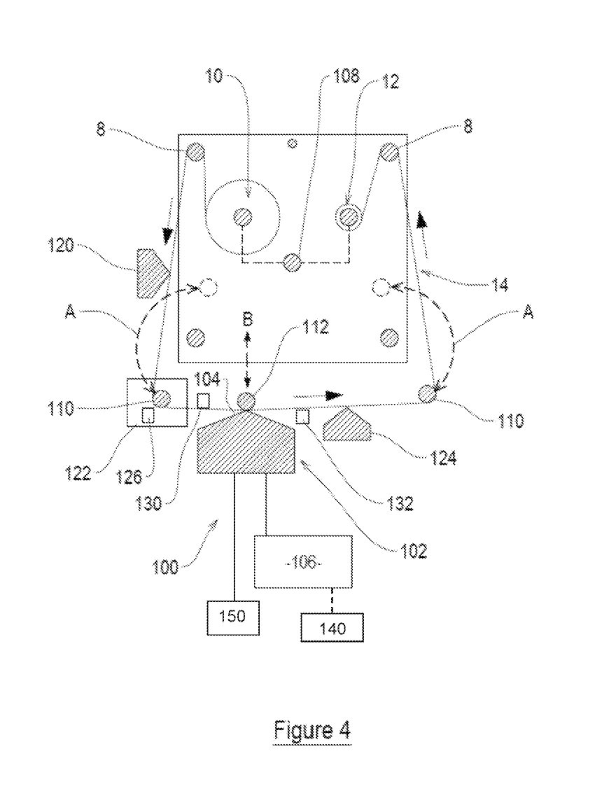

As illustrated in FIGS. 3 and 4, the re-inking device 100 comprises a controller 106, at least one motor 108 and an application mechanism 102. The controller 106 is communicable with and is operable to control components of the re-inking device 100. The physical position of the controller 106 is unimportant for the purpose of describing the present invention, and is shown in FIGS. 3 and 4 by way of example only. Communication between the controller 106 and components of the re-inking device 100 may be via a physical and/or wireless connection. The controller 106 is operable to control operations of the motor 108, the application mechanism 102 and one or more tape monitors (described below). The controller 106 is also operable to control movement of moveable guide members 110, 112 (described in detail below) and movement of the application portion 104 if required. It should be appreciated that there can be separate, independent controllers which are operable to control each component or a group of components of the re-inking device 100 independently.

The application mechanism 102 includes an application portion 104 and a supply of ink 150, which is operable to supply ink to the application portion 104. In some embodiments, the supply of ink 150 includes a reservoir or tank for holding hot melt ink. The reservoir or tank is fluidly connected to the application portion 104. Ink is transferrable from the reservoir to the application portion 104 using, for example, a pump. The reservoir or tank is temperature controlled to ensure that the ink remains at a usable temperature (or within an ideal range of temperatures). The reservoir or tank may be refilled as required or may be connected to a continuous supply of ink 150 from another source. The application portion 104 may include, for example, an anilox roller, a slot die, a blade/knife coater or any other suitable coating mechanism. An appropriate means of supplying ink to the application portion 104 will be selected, dependent upon the type of coating mechanism employed.

The re-inking device 100 has two guide members 110 (although it should be appreciated that the re-inking device 100 may have more than two guide members 110, or fewer). The guide members 110 are moveable between a first position and a second position, as illustrated by arrows “A”, in FIG. 4. In the first position, the guide members 110 are located within a perimeter of the cassette 4. The tape 14 which extends between the first and second spools 10, 12 of the cassette 4 follows an initial tape path, which, in some embodiments, extends along three sides of the cassette 4, around the cassette guide members 8 (see FIG. 3). This initial tape path defines a boundary. The guide members 110 are positioned within the boundary defined by the initial tape path. In the second position, the guide members 110 are located outside of the boundary of the initial tape path.

Therefore, as the guide members 110 move from the first positions to the second positions, they move “outside” of the boundary of the tape path, contact the tape 14 and move it.

Once in the second position, the tape 14 is in a re-inking tape path (FIG. 4) and is in an ink-application position, wherein the application portion 104 is in contact with or adjacent the tape 14.

The application mechanism 102 includes an additional guide member 112, which is moveable relative to the application portion 104 to sandwich the tape 14 between the additional guide member 112 and the application portion 104 when the tape 14 is in the re-inking tape path. The additional guide member 112 is moveable between a first position and a second position (illustrated by arrow “B” in FIG. 4). The first position is within the boundary of the initial tape path. The second position is adjacent the application portion 104 (outside of the boundary of the initial tape path).

In the illustrated example, the application portion 104 does not move substantially to arrive at the ink-application position. However, the application portion 104 may also be moveable from a first position, not in contact with the tape 14, to a second position, in which a part of the application portion 104 is in contact with the tape 14. In other words, the application portion 104 and the additional guide member 112 are moveable relative to one another to sandwich the tape 14 between them, in the ink-application position.

In some embodiments, the re-inking device 100 includes at least one tape monitor to monitor one or more properties of the tape 14. In some embodiments, the re-inking device 100 includes one or more of a damage detector 120, a tape tension detector 122 and an ink detector 124.

The damage detector 120 is positioned to assess the tape 14 as it travels past the damage detector 120 during use of the re-inking device 100. The damage detector 120 may use one or more of optical, ultrasonic, or other techniques. Damage to the tape 14 may include one or more of tearing, breakage, distortion and/or stretching and/or other issues with the tape 14 that may affect the usability of the tape 14. The damage detector 120 monitors the tape 14 and assesses whether the tape 14 is usable (irrespective of whether there is sufficient ink on the tape 14 to perform a printing operation). Any extensive damage (i.e. damage that requires replacement of the tape 14) may be alerted to an operator immediately (for example, visually and/or audibly) and/or an alert signal is sent to the controller 106. Lesser or minimal damage may be recorded (by the damage detector 120 or the controller 106) and used for determining a lifetime of the tape 14 and/or to estimate when the tape 14 should be replaced.

In the illustrated example, the tape tension detector 122 is incorporated with one of the guide members 110 of the re-inking device 100. However, it should be appreciated that the tape tension detector 122 can also be a standalone component of the re-inking device 100.

The tape tension detector 122 detects and/or monitors the tension in the tape 14 as it travels between the spools 10, 12, when the cassette 4 is received by or engaged with the re-inking device 100. The tape tension detector 122 may detect and/or monitor tension in the tape 14 when the tape 14 is moving and/or stationary. There is an optimum tension range of the tape 14 which defines an acceptable operating range for the re-inking device 100. If the tension in the tape 14 is above the acceptable tension range, the tape 14 may become stretched, distorted or break owing to the high tension in the tape 14. If the tension in the tape 14 is below the acceptable range, then the tape 14 may become slack, which may result in unacceptable recoating of the tape 14 and/or the tape 14 may slip off a part of one or both of the cassette 4 and the re-inking device 100.

In some embodiments, an angle detector 126 may be incorporated with the tension detector 122. The angle detector 126 detects whether the tape 14 is moving consistently around the guide members 110 and onto the first and/or second spool 10, 12. In other words, the angle detector 126 detects whether all points across a cross-section of the tape 14 travel substantially parallel with a main face of the cassette 4 (i.e. the face upon which the spools 10, 12 and cassette guide members 8 are attached). If the tape 14 is not travelling substantially parallel to the cassette 4 then the tape 14 may bunch to one side of one or more of the guide members 110 or gradually slip off a free end of one (or more) of the one or more guide members 110. This movement may be a result of distortion on one side of the tape, so that each “side” of the tape 14 moves at a different speed and, thus, the tape 14 migrates along the guide members 110.

In some embodiments, the angle detector 126 sends a signal, relating to the migration of the tape 14, to the controller 106, so that the controller 106 can counteract the migration that is detected in the tape 14. The angle of one of the one or more guide members 110, relative to the cassette 4 (when the cassette 4 is received by and/or engaged with the re-inking device 100) is adjusted. In this example, the guide member 110 which incorporates the tape tension detector 122 and angle detector 126 is adjusted. This process maintains the tape 14 in the defined tape path more accurately.

The ink detector 124 is configured to assess ink on the tape 14 (this may be all freshly applied ink, all existing ink, or a combination of existing ink and fresh ink). The ink detector 124 is located downstream of the application mechanism 102, so that the ink detector 124 can assess the freshly applied ink from the application mechanism 102. However, the ink detector 124 can be located elsewhere.

The ink detector 124 has an emitter and one or more receivers. For example, the ink detector 124 may include an electromagnetic emitter which emits a signal towards the tape 14. An electromagnetic receiver may detect the intensity of the signal which passes through the tape 14 and/or is reflected from the tape 14. The intensity of the signal detected by the or each receiver is used to determine one or more aspects of the ink on the tape (for example, the consistency of the coating of ink (i.e. if the coating is even or patchy), and/or the thickness of the coating of ink).

The at least one tape monitor to monitor one or more properties of the tape 14 is configured to send information to the controller 106 about the one or more properties of the tape 14 that the at least one tape monitor is monitoring.

In some embodiments, the application mechanism 102 includes an ink melting device 130. The ink melting device 130 is operable to melt or soften existing ink that is on the tape 14 (preferably prior to the application of fresh ink, but not necessarily). Softened or melted ink is more easily combined with fresh ink being applied to the tape 14, by the application portion 104, and is, therefore, more likely to result in a uniform coating of ink on the tape 14.

In some embodiments, the re-inking device 100 includes an ink removal device 132. The ink removal device 132 is operable to adjust the thickness of the coating of ink. Primarily, the ink removal device 132 is operable to reduce the thickness of at least a portion of the coating of ink on the tape 14 as necessary (for example, to provide a uniform coating of ink on the tape 14). The ink removal device 132 may, for example, be a shaving device which is positioned to remove a top layer of ink from the tape 14 and provide a uniformly thick coating of ink. The ink removal device 132 may be positioned ‘upstream’ or ‘downstream’ of the application portion 104, or there may be two ink removal devices 132; one upstream and one downstream of the application portion 104.

It is important to produce as uniform a coating of ink on the tape 14 as possible. If, for example, there was a “double coating” (i.e. a double layer of ink applied to one or more portions or areas of the tape 14) then this can result is distortion of the tape 14 and/or unacceptable printing quality. Thus, the ink melting device 130 and/or ink removal device 132 contribute to producing a uniform coating of the ink on the tape 14.

In some embodiments, the re-inking device 100 includes a cooling mechanism to cool the ink after it has been applied to the tape 14. The cooling mechanism may include one or more temperature controlled rollers, which reduce the temperature of the ink after it has been applied to the tape 14, so as to ensure that the ink adheres to the ‘ink side’ of the tape 14 and does not stick the layers of tape 14 together, or separate from the tape 14 as the tape 14 is wound on to the spool 10, 12. Additionally or alternatively, the cooling mechanism may include an air dispenser, which directs a temperature controlled air stream towards the tape 14, downstream of the application portion 104, to cool the ink to an acceptable temperature after application to the tape 14. The dispenser may be configured to direct the airstream in such a way that the airstream aids in ensuring a smooth and/or uniform coating of ink. It will be appreciated that a cooling mechanism is optional, and sufficient cooling of the ink after application to the tape 14 may be achieved by convection. The necessity for a cooling mechanism will depend on the speed of the tape through the re-inking device 100.

The method of re-inking the tape 14 will now be described with reference to the components of the printing apparatus 1 and the re-inking device 100 already described. Generally, the method of re-inking the tape 14 includes the steps of mounting the cassette 4 on the re-inking device 100, initialising the re-inking device 100 and coating at least a portion of the tape 14 with ink.

Once the cassette 4 is mounted on the re-inking device 100, the cassette 4 is positioned adjacent the application mechanism 102 and the structure of the re-inking device 100 is such that the tape 14 is appropriately positioned relative to other components of the re-inking device 100. The cassette 4 may be removed from the printing apparatus 1 and mounted on the re-inking device 100 straight away. Alternatively, the cassette 4 may be removed from the printing apparatus 1 and stored elsewhere before being mounted to the re-inking device 100, rather than being transferred straight to the re-inking device 100. In this case, the printing apparatus 1 may have multiple cassettes 4 assigned to it, so that one cassette 4 is being used in the printing apparatus 1 while another is in the re-inking device 100 (or multiple cassettes 4 are stored either for use in the printing apparatus 1 or to await mounting on the re-inking device 100).

In some embodiments, as the cassette 4 is mounted on the re-inking device 100, the or each motor 108 of the re-inking device 100 is connected to the first and/or second spool 10, 12. As such, when the controller 106 controls the operation of the motor(s) 108, it also controls the rotation of the first and second spools 10, 12 to transfer the tape 14 between the spools 10, 12.

In some embodiments, substantially all of the tape 14 is transferred onto the first spool 10 (or the second spool 12) prior to initialising the re-inking device 100 (described below). This allows efficient re-inking of the tape 14 because substantially all of the tape 14 can be moved past the application mechanism 102 without having to reverse the direction of the tape 14. It should be appreciated that this is an optional step, and depending on the portion of tape 14 which is to be coated with ink, may not be required. Throughout the description, when referring to “substantially all of the tape 14” it is intended to mean substantially the entire length of the tape 14 (it should be appreciated that there may always be a portion of the tape 14 that cannot be used in a printing operation or coated in ink because it is so close to an end of the tape 14 that it cannot reach the printhead or the application portion 104).

The re-inking device 100 initialises by moving at least one of the tape 14 and application portion 104 relative to the other to bring the tape 14 into an ink-application position (this is an initialising step). The initialising step includes the controller 106 moving the guide members 110 of the re-inking device 100 to their second positions (and altering the length of the tape path). In other words, the guide members 110 “pull” the tape 14 outwards to bring the tape 14 into the ink-application position (illustrated by the dashed arrows referenced by “A” in FIG. 4).

The controller 106 also causes the additional guide member 112 to move to its second position (which may also alter the length of the tape path) and brings the tape 14 closer to the application portion 104 (this is illustrated by the dashed arrow referenced “B” in FIG. 4).

It should be appreciated that the initialising step can involve the controller 106 controlling the movement of the application portion 104 towards the tape 14. A combination of both methods (i.e. moving the application portion 104 and the guide members 110, 112) can be used to position the tape 14 and the application portion 104 in the ink-application position.

A coating step is performed after the initialising step. The controller 106 operates the motor(s) 108 to rotate one or both of the spool supports 6a, 6b of the cassette 4 (and, thus, the first and/or the second spool 10, 12 are rotated to transfer tape 14 between the spools 10, 12).

The coating step may include an optional tape preparation step, which prepares the tape for receiving a coating of fresh ink. The preparation step may include using the ink melting device 130 to melt or soften some or all of the existing ink on the tape 14 before applying fresh ink. Melting the existing ink on the tape 14 before applying fresh ink allows the application mechanism 102 to combine the existing ink with the fresh ink more easily, which results in a more consistent and uniform coating of ink on the tape 14. It will be appreciated that the temperature of the fresh ink may also have an effect on the viscosity of the existing ink on the tape 14, which may aid combination of the existing ink and the fresh ink. Additionally or alternatively, the preparation step may include using an ink removal device 132 which is positioned upstream of the application portion 104, to remove existing ink from the tape 14 prior to coating with fresh ink.

The controller 106 controls the supply of ink 150 such that an amount of ink is provided to the application portion 104 from the reservoir or tank. At least a portion of the tape 14 is coated with ink by supplying ink (from the reservoir or tank using the pump) to the application portion 104 and moving the tape 14 past the application portion 104 as the application portion 104 releases ink towards the tape 14. As the tape 14 travels around the re-inking tape path, successive portions of the tape 14 pass the application portion 104 so that ink may coat some or all of the successive portions of the tape 14.

Optionally, substantially all of the tape 14 is transferred from the first spool 10 to the second spool 12 past the application portion 104, and as such substantially all of the tape 14 is coated with ink. Depending on the amount of the tape 14 that requires recoating with ink, all of the tape 14 may not be transferred past the application portion 104. The tape 14 that is transferred past the application portion 104 is transferred in one continuous phase. However, it should be appreciated that the tape 14 may be transferred past the application portion 104 in multiple, intermittent successive phases, as desired.

The thickness of the coating of ink on the tape 14 may be around 5 μm or less than 5 μm. In some embodiments, the tape 14 travels past the application portion 104, during the coating step, at a speed of between 0.4 and 0.6 metres per second. The speed may be around 0.5 metres per second.

In some embodiments, the coating step includes using the ink removal device 132 (which is downstream of the application portion 104) to remove excess ink from the tape 14. This may include using a shaving device to remove a “top” layer of ink from the tape 14 and ensuring a consistent and uniform coating of ink on the tape 14.

After the coating step, substantially all of the tape 14 is wound onto the first spool 10 (or the second spool 12). This prepares the cassette 4 for reinsertion into the thermal printing apparatus 1. This is beneficial because the cassette 4 is then ready for printing immediately after the cassette 4 is reinserted into the printing apparatus 1, so printing can recommence more quickly. It should be appreciated that this is an optional step. If only a portion of the tape 14 has been coated with ink then the controller 106 may not include this step. Additionally, the cassette 4 can be reinserted into the printing apparatus 1 with any amount of tape 14 on either of the first and second spools 10, 12 if required.

As discussed above, the re-inking device 100 includes the damage detector 120, the tape tension detector 122 and the ink detector 124. These detectors 120, 122, 124 may monitor properties of the tape 14 at any stage during the re-inking method as desired.

For example, the damage detector 120 may be used primarily when the re-inking device 100 is not performing the coating step (because coating the tape 14 may result in temperature distortion as the ink is applied to the surface, whereas when the tape 14 is cool/in a normal environment and/or at a normal ambient/operating temperature there is no distortion present). Therefore, the damage detector 120 may use the period in which substantially all of the tape is being wound onto the first spool 10 (or the second spool 12) before the initialising step and/or after the coating step in which to detect damage to the tape 14.

The tape tension detector 122 may be used continuously or intermittently throughout the re-inking method to ensure that the tape 14 moves stably through the re-inking device 100 and that the tape 14 is maintained within an acceptable tension range.

The ink detector 124 detects the absence/presence of ink on the tape 14, and the consistency with which the ink has been coated on the tape 14 (i.e. detecting that the coating is an acceptable thickness throughout the application). It should be appreciated that if the ink detector 124 is located somewhere other than downstream from the application portion 104, then the ink detector 124 may be used at another stage of the re-inking method (rather than the coating step). In other words, the ink detector 124 detects ink on the tape 14 concurrently with the coating step, by looking at a different portion of tape 14 from the portion of the tape 14 being coated. Alternatively, the ink detector 124 can detect ink on the tape 14 in a standalone step or as the tape 14 is rewound on to one of the first and second spools 10, 12.

In the event that any of the detectors 120, 122, 124 of the re-inking device 100 detects any anomalies then a signal may be sent to the controller 106. The controller 106 will provide an alert for an operator and/or send an alert to a central system 140 which manages the schedule of one or more re-inking devices 100. For example, the controller 106 may be configured with a predetermined threshold of the number of anomalies and/or severity of a single anomaly. An alert may be made if that threshold or severity is exceeded.

The method of re-inking the tape 14 further includes a completion step where components of the re-inking device 100 move out of contact with the tape 14. Generally, the completion step may be the reverse of the initialising step discussed above. In other words, the guide members 110 may move back to their first positions, within the boundary of the initial tape path, and the tape 14 returns to its initial position (i.e. around each of the cassette guide members 8). Likewise, the additional guide member 112 adjacent the application portion 104 also moves away from the tape 14. If the application portion 104 moved during the initialising step, then the application portion 104 also returns to its initial position.

The re-inking device 100 is advantageous because it can be used to serve multiple printing apparatuses. A single re-inking device 100 may be able to service at least ten printing apparatuses. Many existing printing apparatuses have the tape mounted on a removable/replaceable cassette. An advantage of the present invention is that the re-inking device 100 and the re-inking method are intended to be compatible with existing printing apparatuses and cassettes. The invention can be incorporated into existing installations, without the need to modify existing printing apparatuses or cassettes.

The central system 140 controls the management of the re-inking device 100 and re-inking of tape on different cassettes (e.g. cassettes from multiple printing apparatuses or multiple cassettes from the same printing apparatus). The central system 140 may have a network connection to the printing apparatuses it “serves”. Therefore, the central system 140 may have knowledge of the amount of ink remaining on tapes currently in use and schedule an order in which the cassettes should be inserted into the re-inking device 100, in order to minimise “down time” of the printing apparatuses. It should be appreciated that the central system 140 may be part of the re-inking device 100 or a standalone component.

It may be advantageous to remove a cassette 4 from a printing apparatus 1 before the tape 14 has been completely used (i.e. before all of the tape 14 is transferred from the first spool 10 to the second spool 12 past the printhead). Instead the cassette 4 may be removed at a convenient time in relation to the printing apparatus 1 instead (i.e. during a normal production stoppage point—which can be for example, substrate changeover, a personnel/operator change or maintenance) such that additional down time is minimised. This means that in a production line, the printing apparatus 1 will not be the main cause of production line stoppage because re-inking the tape 14 can be coordinated with other scheduled stops.

A further advantage of this method of operation includes the tape 14 having a longer lifetime because the operator does not handle the tape 14 (because the user moves the cassette 4 with the tape 14 already fitted). Damage to the tape 14 is also reduced for the same reason, meaning that there is a reduction in waste tape (and, as such, less plastic material is discarded). Additionally, the tape 14 is effectively recycled each time it is recoated with ink, which is beneficial for the environment. The tape 14 should be able to be recoated at least 10 times before it requires replacement.

Minimising the handling of the tape 14 also means that the operator does not need to be as skilled in handling techniques.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A method of re-inking a tape, at least a part of the tape being wound onto each of a first spool and second spool and the tape extending between the first spool and the second spool along a tape path, the first and second spools being mounted to a cassette of a thermal printing apparatus, the method using a re-inking device including an application mechanism, which includes an application portion and a supply of ink configured to supply ink to the application portion, the method comprising:
mounting the cassette on the re-inking device,
initialising the re-inking device by moving at least one of the tape and the application portion relative to the other to bring the tape into an ink-application position, and
coating at least a portion of the tape with ink by supplying ink to the application portion and rotating at least one of the first and second spools to move the tape relative to the application portion, so that ink coats at least a portion of the tape.

2. A method according to claim 1 comprising removing the cassette from a thermal printing apparatus, prior to mounting the cassette on the re-inking device.

3. A method according to claim 1 comprising providing a moveable guide member which, during the initialising, moves from a first position, to a second position in which the guide member contacts the tape.

4. A method according to claim 1 wherein at least a part of the application mechanism is moveable from a first position, to a second position in which the part of the application mechanism is in contact with the tape.

5. A method according to claim 4 wherein the part of the application mechanism is the application portion.

6. A method according to claim 1 comprising transferring substantially all of the tape onto one of the first spool, or the second spool, prior to initialising the re-inking device, and moving at least a portion of the tape past the application portion such that at least a portion of the tape is coated with ink, during the coating.

7. A method according to claim 1 comprising moving substantially all of the tape past the application portion such that substantially all of the tape is coated with ink, during the coating.

8. A method according to claim 1 comprising transferring substantially all of the tape onto the first spool, or second spool, after the coating, so that the cassette is prepared for reinsertion into a thermal printing apparatus.

9. A method according to claim 1 comprising monitoring at least one property of the tape in the tape path.

10. A method according to claim 9 wherein the monitoring includes using a tape tension detector to monitor the tension in the tape and/or an angle detector to monitor the angle of the tape in the tape path.

11. A method according to claim 9 comprising correcting or maintaining the tension in the tape in the tape path within acceptable limits or towards a predetermined range, and/or comprising correcting or maintaining the angle of the tape in the tape path within acceptable limits or towards a predetermined range when the angle detector detects a divergence from the predetermined range.

12. A method according to claim 10, wherein correcting or maintaining the tension and/or the angle of the tape in the tape path includes using a guide member.

13. A method according to claim 9 comprising monitoring at least a portion of the ink on the tape to detect the presence and/or absence of ink on the tape, using an ink detector, and/or wherein monitoring at least a portion of the ink on the tape includes using an electromagnetic sensor, and optionally wherein using the electromagnetic sensor includes emitting electromagnetic radiation towards the tape and monitoring the intensity of the electromagnetic radiation that travels through the tape and/or monitoring the intensity of the electromagnetic radiation that is reflected by the tape.

14. A method according to claim 9 comprising monitoring the tape for damage and/or wear, using a damage detector.

15. A method according to claim 9 comprising alerting an operator and/or a central system of a detected anomaly.

16. A method according to claim 1 comprising adjusting a thickness of a portion of the ink coated on the tape using a shaving device.

17. A method according to claim 1 wherein the coating comprising melting at least a portion of existing ink on the tape.

18. A method according to claim 1 wherein the coating, which results in at least a portion of the tape being coated in ink, comprising moving the tape relative to the application portion at a speed of between 0.1 and 0.6 metres per second.

19. A method according to claim 18 wherein the speed is around 0.5 metres per second.

20. A re-inking device comprising:
an application mechanism comprising an application portion and a supply of ink, which is operable to supply ink to the application portion;
the re-inking device being configured to receive and/or engage a cassette of a printing apparatus, the cassette including a first spool and a second spool and a tape of which at least a part is wound onto each of the first spool and the second spool and the tape extending between the first spool and the second spool along a tape path, and
the re-inking device being operable to apply ink to a portion of the tape when the cassette is received and/or engaged with the re-inking device.
